(19) United States
(12) Patent Application Publication
(10) Pub. No.: US 2019/0070624 A1
(43) Pub. Date: Mar. 7, 2019

(54) Protective Floor Covering

(71) Applicant: Cliff Holt, Hobart, IN (US)

(72) Inventor: Cliff Holt, Hobart, IN (US)

(21) Appl. No.: 16/125,137

(22) Filed: Sep. 7, 2018

Related U.S. Application Data
(60) Provisional application No. 62/555,574, filed on Sep. 7, 2017.

(51) Int. Cl. B05B 12/20; B05C 21/00

(52) U.S. Cl. CPC B05B 12/20; B05C 21/005

(57) ABSTRACT

A protective floor covering. The protective floor covering includes an edge member attached to a cover. The cover is flexible and durable and is designed to protect a floor from paint or other damaging materials. The edge member is designed to secure the cover in a desired position and to be inserted between or adjacent to a floor and a trim. The edge member can have an adhesive disposed on one or both sides thereof.

### CROSS REFERENCE TO RELATED APPLICATIONS

This application claims the benefit of U.S. Provisional Application No. 62/555,574 filed on Sep. 7, 2017. The above identified patent application is herein incorporated by reference in its entirety to provide continuity of disclosure.

### BACKGROUND OF THE INVENTION

The present invention relates to a protective floor covering. More specifically, the present invention relates to a protective floor covering that provides a substantially rigid edge member configured to slide between a floor and a trim of a wall.

Many people enjoy painting the interior walls of their home or business. Many methods, such as using brushes, rollers or sprayers may be utilized to complete a painting project on an interior wall. Regardless of the method used by the painter, an excessive amount of clean-up may be required after the project is completed. Furthermore, some surfaces, such as carpet and wood, may be damaged by paint or chemicals that are utilized to remove paint.

Commonly, a painter will use painter's tape and other makeshift barriers to protect the floor from paint spills. However, placing painter's tape or a similar adhesive around the edges of the wall to be painted can be a time-consuming and expensive process. Additionally, painting tape does not provide sufficiently protection to a floor due to the lack of surface area provided. Furthermore, when painting tape is applied, the removal of the painting tape itself may cause damage. For example, when painting tape is removed from a surface, such as a finished trim, paint can be removed from the trim, creating additional work or repair costs.

Other painters may use drop cloths or papers to protect a floor. However, these products typically are not sufficiently durable and will need to be replaced after as little as one project. In addition to being prone to rips and tears, these products are easily moved or knocked out of position, leaving potentially large areas of the floor exposed to paint spills and drips.

Therefore, there is a need in the known art for a device that will more efficiently and more effectively cover and protect a floor while a room is being painted. More specifically, the device should provide a user with ease of deployment and removal, such as to expediate the process of painting a room of a home or business.

### SUMMARY OF THE INVENTION

In view of the foregoing disadvantages inherent in the known types of floor protection apparatuses now present in the known art, the present invention provides a protective floor covering wherein the same can be utilized for providing convenience for the user when providing protection to a floor during a painting process.

The present system comprises a protective floor covering having a cover made of a flexible material. An edge member is disposed around at least one edge portion of the cover. The edge member is dimensioned such that the edge member can be slid between a floor and a trim of a wall.

In one embodiment, the protective floor covering comprises an edge member made of a flexible material, such that the edge member can be folded for storage and inserted easily between the floor and the trim.

In another embodiment, the protective floor covering comprises an adhesive. The adhesive is disposed on at least one of the cover and the edge member, such that the protective floor covering will not slide or move during use.

In a further embodiment, the protective floor covering further comprises an adhesive cover that is removably disposed on the adhesive, such as to prevent the adhesive from being overexposed and losing efficiency.

In yet another embodiment, the edge member is made of a material having a greater density than the material of the cover, such that the edge member will secure the cover in a desired position.

In yet a further embodiment, the upper surface of the edge member tapers toward a lower surface of the edge member from the cover to a distal end of the edge member, such that the edge member can be more efficiently placed between the floor and the trim.

In another embodiment, the protective floor covering further comprises a roll disposed on an end of the cover, such that the cover can be wrapped about the roll to store the protective floor covering.

In yet a further embodiment, the protective floor covering comprises a edge member that is disposed around an entirety of a perimeter of the cover.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the protective floor covering.

FIG. 2 shows a perspective view of an alternate embodiment of the protective floor covering.

FIG. 3 shows a perspective view of another embodiment of the protective floor covering.

FIG. 4 shows a side view of an embodiment of the protective floor covering in use.

FIG. 5 shows a perspective view of an alternate embodiment of the protective floor covering.

### DETAILED DESCRIPTION OF THE INVENTION

Reference is made herein to the attached drawings. Like reference numerals are used throughout the drawings to depict like or similar elements of the protective floor covering. The figures are intended for representative purposes only and should not be considered to be limiting in any respect.

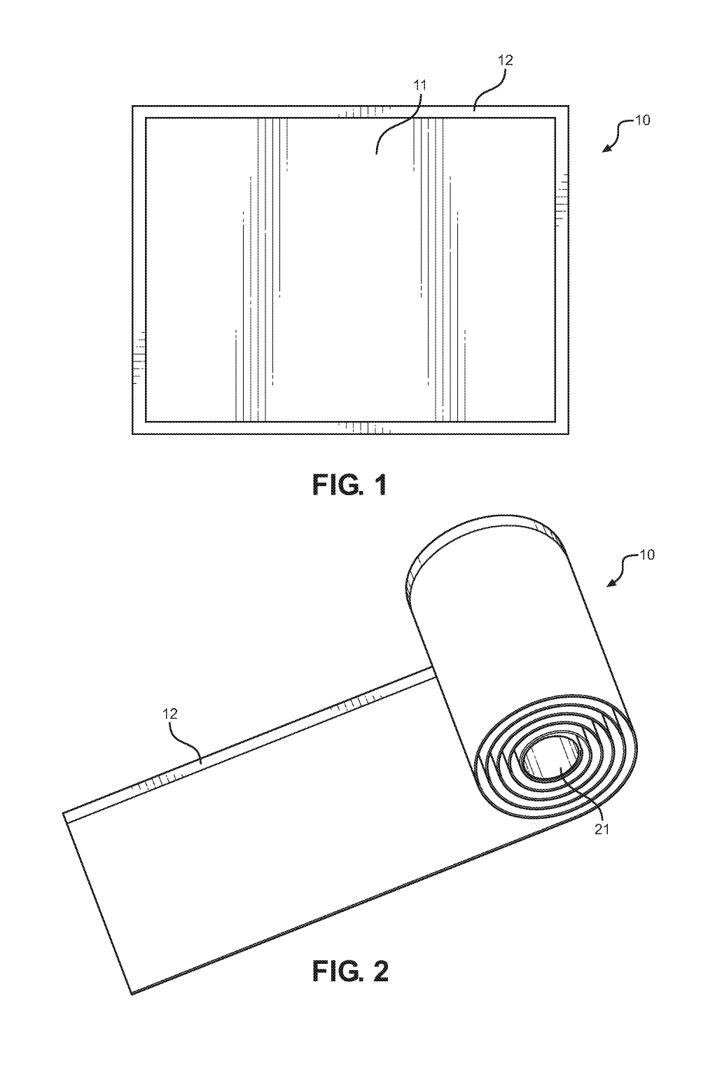

Referring now to FIG. 1, there is shown a perspective view of an embodiment of the protective floor covering. The protective floor covering 10 comprises a cover 11. The cover 11 is made from a flexible material. The use of a cover 11 being made of a flexible material allows for the cover 11 to be easily manipulated, such that it can be disposed over a desired floor of any texture.

An edge member 12 is disposed around at least one edge portion of the cover 11. In the illustrated embodiment, the edge member 12 is disposed around an entirety of a perimeter of the cover 11. The edge member 12 is dimensioned to slide between a floor and a trim, such as to prevent paint from being displaced upon a floor or a trim. In one embodiment, the edge member 12 is made of a material having a greater density than the material of the cover 11, such that the edge member 12 will weigh the cover 11 down, holding the cover 11 in a desired position.

In one embodiment, the edge member 12 is removably disposed around the cover 11 by action of a fastener, such as an adhesive strip. Under this embodiment, the edge member 12 may be oriented into a desired position before the cover 11 is attached thereto.

The edge member 12 is constructed of a material that can be easily cut, such that a user may easily cut the protective floor covering 10 to a desired dimension. In an alternate embodiment, the protective floor covering 10 comprises a plurality of perforations thereon, such that the protective floor covering 10 can be removable in segments.

Referring now to FIG. 2, there is shown a perspective view of an alternate embodiment of the protective floor covering. In the illustrated embodiment, the edge member 12 is made of a foldable material, such that the edge member can be folded or rolled into a stored state. Since the cover 11 is made of a flexible material, when the edge member 12 is made of a foldable material, the protective floor covering 10 can be rolled into a stored state as shown.

In one embodiment, the protective floor covering 10 further comprises a roll 21. The roll 21 is disposed on an end of the cover 11, such that the cover 11 can be wrapped around the roll 21. In a stored state, the roll 21 will prevent the protective floor covering 10 from laying flat upon itself, potentially comprising the structure of the edge member 12 or the cover 11.

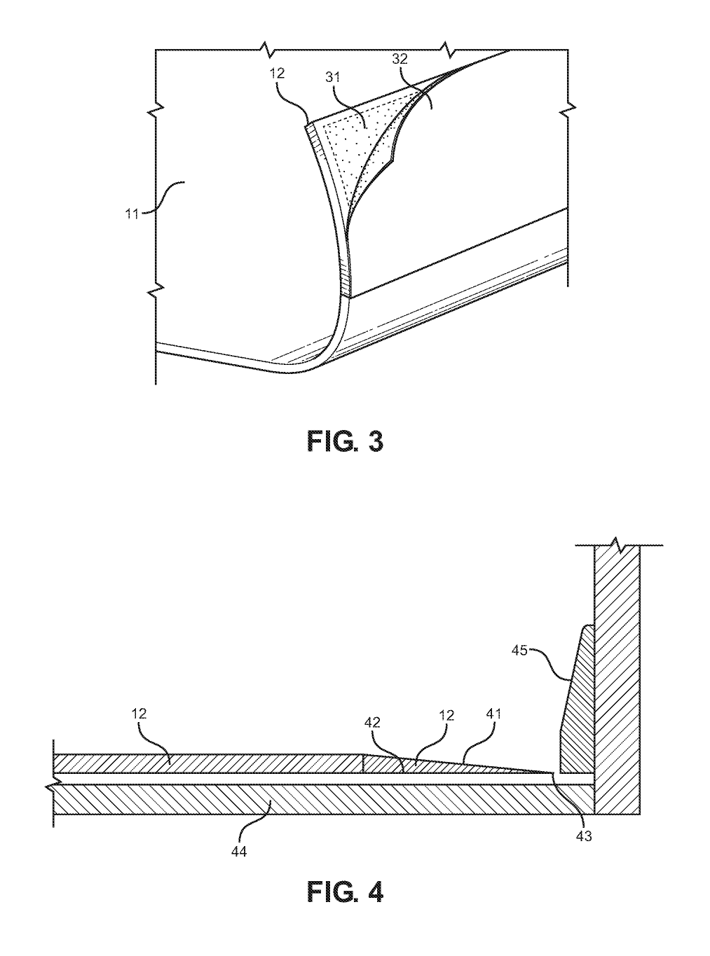

Referring now to FIG. 3, there is shown a perspective view of another embodiment of the protective floor covering. In the illustrated embodiment, the protective floor covering further comprises an adhesive 31 disposed on a lower surface of at least one of the cover 11 or the edge member 12. In the illustrated embodiment, the adhesive 31 is disposed on the lower surface of the edge member 12. The adhesive 31 is configured to secure the protective floor covering to a desired surface, such as a floor or a trim. In the illustrated embodiment, the adhesive 31 is disposed on the entirety of the lower surface of the edge member 12. In alternate embodiments, the adhesive 31 is disposed on only a portion of the lower surface of either the cover 11 or the edge member 12.

Furthermore, in one embodiment, the protective floor covering further comprises an adhesive cover 32 that is removably disposed on the adhesive 31. The adhesive cover 32 is configured to protect the adhesive 31 when the protective floor covering is in a stored state. When the adhesive cover 32 is removed from the adhesive 31, the adhesive 31 can be applied to a desired surface to secure the protective floor covering. In the illustrated embodiment, the adhesive cover 32 is a strip of paper configured to be peeled off the adhesive 31.

Referring now to FIG. 4, there is shown a side view of an embodiment of the protective floor covering in use. In the illustrated embodiment, the edge member 12 is comprised of an upper surface 41 disposed oppositely the lower surface 42. In one embodiment, the upper surface 41 of the edge member 12 tapers toward the lower surface 42 of the edge member from the cover 11 to a distal end 43 of the edge member. The taper allows for the edge member 12 to be more easily inserted into a tight gap, such as a gap between a floor 44 and a trim 45.

In use, the protective floor covering is laid upon a floor 44 in a desired location. The cover 11 disposed over the area that will be stood upon while painting, or otherwise working upon, the desired location. The edge member 12 is inserted into a gap between the floor 44 and the trim 45 such that the edge member 12 and the cover 11 will prevent substances, such as paint, from falling upon the floor 44. When a project is completed, the protective floor covering can be washed and placed into a stored state, such as by being rolled up.

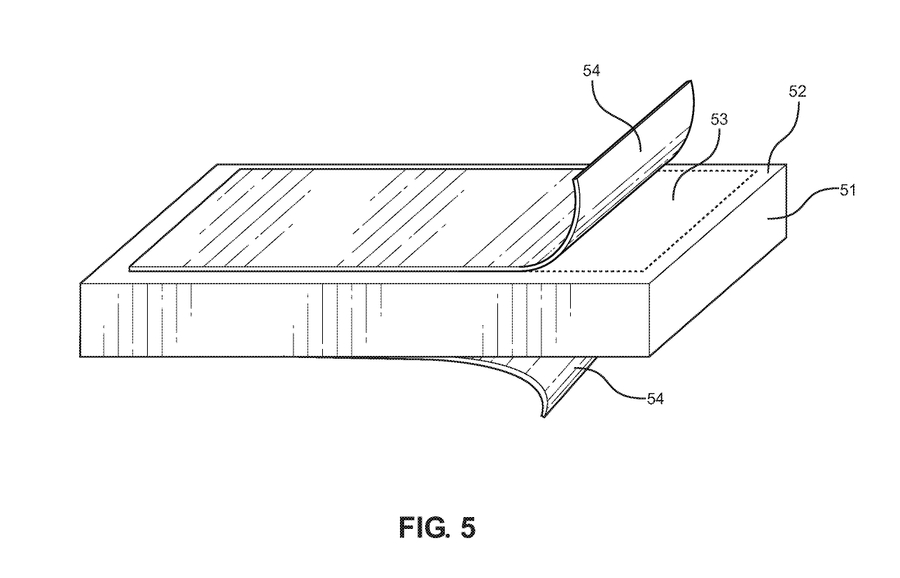

Referring now to FIG. 5, there is shown a perspective view of an alternate embodiment of the protective floor covering. The alternate embodiment comprises an elongated member 51 having an upper surface 52 disposed oppositely a lower surface. The lower surface comprises a first adhesive thereon, while the upper surface 52 comprises a second adhesive 53 thereon. In one embodiment, the elongated member 51 is rigid, such that the elongated member 51 can be placed flush against a wall. Additionally, rigid configuration of the elongated member 51 prevents each adhesive from sticking to itself or the opposing adhesive. In another embodiment, the elongated member 51 is made of a recyclable or composite plastic material.

In one embodiment, the adhesive cover 54 is removably disposed upon each of the first adhesive and the second adhesive 53. The adhesive cover 54 protects the first adhesive and the second adhesive such that the adhesive character thereof will not be compromised. It is an object of the present invention that the second adhesive can receive a drop cloth, or similar article, thereon. In use, the adhesive cover corresponding to the first adhesive is removed to secure the elongated member 51 to a hard floor surface, such as hardwood or tile. Additionally, the adhesive cover 54 corresponding to the first adhesive may remain attached when the elongated member 51 is placed onto a soft floor surface, such as carpet. The first adhesive and the second adhesive are configured to not remove paint from the surface to which each is attached.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes ill readily occur to those skilled in the art, it is not desired to limit the invention to the exact construction and operation shown and described, and accordingly, all suitable modifications and equivalents may be resorted to, falling within the scope of the invention.

I claim:

1) A protective floor covering comprising:
a cover composed of a flexible material;
an edge member removably disposed around at least one edge portion of the cover;
the edge member configured to slide between a floor and a trim.

2) The protective floor covering of claim 1, wherein the edge member is made of a foldable material.

3) The protective floor covering of claim 1, wherein an adhesive is disposed on a bottom surface of the cover.

4) The protective floor covering of claim 3, wherein an adhesive cover is removably disposed on the adhesive.

5) The protective floor covering of claim 1, wherein an adhesive is disposed on a bottom surface of the edge member.

6) The protective floor covering of claim 5, wherein an adhesive cover is removably disposed on the adhesive.

7) The protective floor covering of claim 1, wherein an adhesive disposed on the bottom surface of the cover and on the bottom surface of the edge member.

8) The protective floor covering of claim 7, wherein an adhesive cover is removably disposed on the adhesive.

9) The protective floor covering of claim 1, wherein the edge member is made of a material having a greater density than the cover.

10) The protective floor covering of claim 1, wherein an upper surface of the edge member tapers toward a lower surface of the edge member from the cover to a distal end of the edge member.

11) The protective floor covering of claim 1, wherein a roll is disposed on an end of the cover, such that the cover can be wrapped about the roll.

12) The protective floor covering of claim 1, wherein the edge member is disposed around an entirety of a perimeter of the cover.

13) A protective floor covering, comprising:
an elongated member having an upper surface disposed oppositely a lower surface;
the lower surface comprising a first adhesive thereon;
the upper surface comprising a second adhesive thereon.

14) The protective floor covering of claim 13, further comprising an adhesive cover removably disposed on each of the lower surface and the upper surface.

15) The protective floor covering of claim 13, wherein the first adhesive and the second adhesive are disposed upon the entirety of the lower surface and the upper surface respectively.

16) The protective floor covering of claim 13, wherein the elongated member is made of a rigid material.

17) The protective floor covering of claim 13, wherein the elongated member is made of a composite plastic.
